(19) United States
(12) Patent Application Publication
(10) Pub. No.: US 2010/0090417 A1
(43) Pub. Date: Apr. 15, 2010

(54) SEALING ARRANGEMENT FOR CONNECTIONS ON LINES CONDUCTING HOT GASES, PARTICULARLY EXHAUST GAS LINES ON INTERNAL COMBUSTION ENGINES

(76) Inventors: Wojtek Kolasinski, Nurtingen (DE); Wilhelm Kullen, Hulben (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/450,078

(22) PCT Filed: Feb. 8, 2008
(86) PCT No.: PCT/EP2008/000965

§ 371 Date: Sep. 10, 2009

(30) Foreign Application Priority Data
May 7, 2007 (DE) 10 2007 021 221.8

(51) Int. Cl. F02F 11/00

(52) U.S. Cl. 277/597

(57) ABSTRACT

The invention relates to a sealing arrangement for connections on lines conducting hot gases, particularly exhaust gas lines on internal combustion engines, having at least one sealing element (9) closing a gas channel relative to the outer side thereof in a gas-tight manner, characterized in that the sealing arrangement (1) comprises a means (13, 15, 21) for reducing the thermal load of the sealing element (9).

The invention relates to a sealing arrangement for connections on lines conducting hot gases, particularly exhaust gas lines on internal combustion engines, with at least one sealing element which encloses the pertinent gas channel gastight relative to its outer side.

Advanced developments in engineering in the field of internal combustion engines, specifically with respect to compact and lightweight constructions and especially with respect to optimization of consumption and increased power, lead to rising demands for the stability of seal connections under load in hot exhaust gas areas. This relates especially to seal connections on the transitions between the exhaust gas manifold and turbocharger, exhaust gas manifold and catalytic converter or turbocharger and exhaust gas pipe. Stresses which occur in these zones often lead to greatly reduced fatigue strengths of the affected sealing arrangements.

With respect to these problems, the object of the invention is to make available a sealing arrangement for lines which conduct hot gases, particularly exhaust gas lines, which especially satisfy the demands to be imposed on the fatigue strength.

This object is achieved according to the invention by a sealing arrangement which has the features of claim 1 in its entirety.

The important particular of the invention accordingly consists in that there is a means which counteracts the thermal stress on the sealing element. As has been shown, rising temperatures as can occur in modern systems on critical zones lead primarily to a reduction of the fatigue strengths; this means that measures which reduce the thermal loading of the sealing element lead to much improved fatigue strengths.

The arrangement in this connection can be made such that the means intended for reducing the thermal load acts directly on the sealing element and/or the connecting flange of the line connection which forms the sealing arrangement.

This can take place by a heat-dissipating means, that is, by a cooling structure with a cooling action on the sealing element itself or on the connecting flange, or both on the sealing element and also on the connecting flange.

Alternatively, there can be a heat-insulating means, in turn dynamically connected to the connecting flange or the sealing element or both to the former and to the latter.

Furthermore, the arrangement can be such that there is a means which effects combined cooling and heat insulation, in turn with action on the sealing element or connecting flange or both on the former and also on the latter.

In one particularly advantageous embodiment with the use of a heat-dissipating means, the arrangement can be such that the sealing arrangement comprises a space for a liquid or gaseous cooling medium.

In this connection the space for the cooling medium can have one or more coolant channels.

The space for the cooling medium can be configured at least partially within the sealing element, and the arrangement can be designed such that the space is connected to cooling channels located outside the sealing element.

In especially advantageous embodiments the outside cooling channel can be provided with external cooling ribs for heat dissipation.

Alternatively or in addition, the cooling channels can be connected to an active, external cooling circuit.

The sealing element can be designed with several layers with one external sealing layer at a time which seals on the contact surface or flange surface, the space for the cooling medium and/or an intermediate layer with good heat conduction being located between the external sealing layers of the sealing element.

The arrangement can be such that there is insulating material as a heat-insulating means between the flange surfaces and facing surfaces of the sealing element.

In embodiments in which between the sealing external seal layers there is an intermediate layer with good heat conduction, this end region which forms with heat dissipation surfaces can project to the outside over the external ends of the sealing layers.

The invention is detailed below using embodiments shown in the drawings.

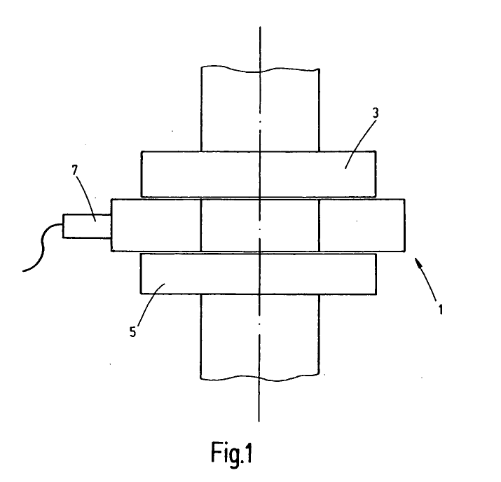

FIG. 1 shows a highly schematically simplified sketch in explanation of the basic principle of the invention;

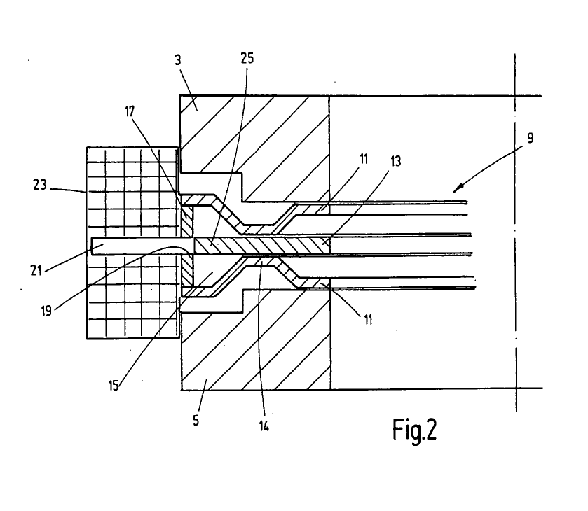

FIG. 2 shows an exaggerated, highly schematically simplified and half-side longitudinal section of a first embodiment of the sealing arrangement and

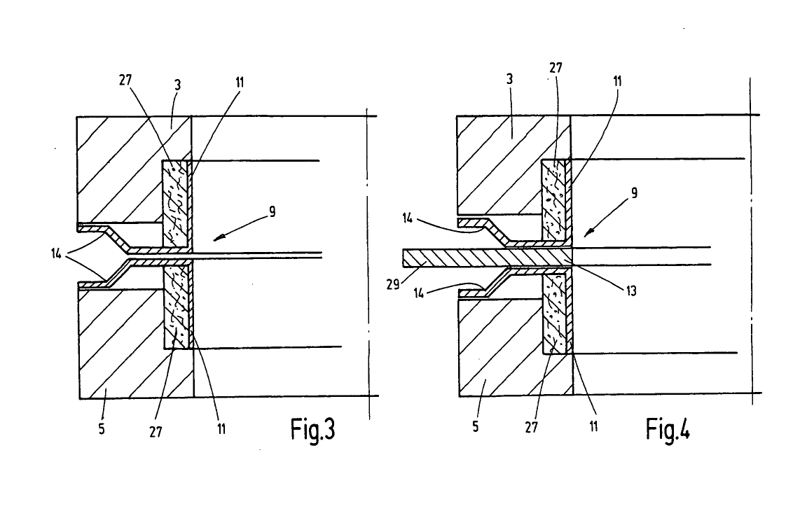

FIGS. 3 to 8 of FIG. 2 show similar representations of other embodiments of the sealing arrangement according to the invention.

FIG. 1 illustrates the use of the sealing arrangement according to the invention at one connecting site of an exhaust gas line system, for example, at the transition site between the manifold and the turbocharger of an internal combustion engine, the sealing arrangement 1 forming the seal between the connecting flange 3 on the manifold and the connecting flange 5 of the turbocharger. As the means for reducing the thermal load of the sealing element of the sealing arrangement 1 during system operation, the sealing arrangement 1 is designed as a sealing cooling structure whose configuration is detailed below using the embodiments shown in FIGS. 2 to 8. As already indicated, the operating principle of the cooling structure consists in that there are active or passive heat dissipation, measures for heat insulation or a combination of heat dissipation and heat insulation. In the representation from FIG. 1 the sealing arrangement 1 is additionally provided with a temperature sensor means 7 which during use of active cooling means controls their operation.

FIG. 2 shows a first embodiment of the sealing arrangement 1 formed from a connecting flange 3, connecting flange 5 and sealing element 9 installed in between, the sealing element 9 being designed with several layers. There are two external sealing layers 11 here of crimped sheet metal for sealing contact of the crimps 14 with the connecting flange 3 and the connecting flange 5. Between the sealing layers 11 there is an intermediate layer 13 with good heat conductivity, consisting of a material with good heat conductivity, in the embodiment of copper sheet. As is apparent from FIG. 2, the crimps 14 on the external sealing layers 11 are made such that the external sealing layers 11 at a distance from the external end of the sealing element 9 adjoin the internal intermediate layer 13, the sealing layers 11, however, extending against the outer end in a divergent manner so that a space 15 is formed which borders the intermediate layer 13 on both sides. The space is intended for holding a gaseous or liquid cooling medium and is closed on the outer end by a sealing sheet 17. The space 15 is connected by way of a passage 19 in the sealing sheet 17 to external cooling channels 21 which in the illustrated embodiment are held in a cooling body 23 which has cooling ribs or, in the case in which there is active cooling, are connected to a coolant circuit.

In this example, the thermal load of the sealing element 9 is reduced by heat dissipation, heat transport taking place in particular by way of the end region 25 of the heat conducting intermediate layer 13 to the cooling medium located in the space 15, from which the heat is dissipated to the outside via the cooling channels 21.

FIG. 3 shows an embodiment in which the thermal load is reduced by heat insulation. As above, the sealing element 9 is in turn designed with several layers, specifically with external sealing layers 11 of crimped sheet metal which seal on the external crimps 14 on the connecting flanges 3 and 5. The other surfaces of the sealing layers 11 facing the connecting flanges 3 and 5 are, however, not in direct contact with the connecting flanges 3 and 5 which have high temperatures in operation, but are insulated from the flanges 3 and 5 by way of an annular body which consists of an insulating material 27, which is made comparatively thick-walled, and which can consist of mica. This heat insulation between the connecting flanges 3 and 5 and the sealing element 9 leads to a reduction of its temperature during operation and thus to a reduction of the thermal load.

The embodiment from FIG. 4 differs from the example from FIG. 3 in that to reduce the thermal load of the sealing element 9 there are both heat insulation according to the example from FIG. 3 and also additional heat dissipation by an intermediate layer 13 which has good heat conduction between the sealing layers 11, the intermediate layer 13 with its end region 29 projecting to the outside so that additional heat dissipation is possible to the outside, for example by direct air cooling, or according to the solution from FIG. 2, by means of an assigned cooling system (not shown).

FIG. 5 in turn illustrates an example in which there is heat dissipation using a space 15 for a cooling medium, the space 15 being located within an inner ring body 31 which is located between external sealing layers 11. This body can be formed by a welded body which, as shown schematically at 33, can have a coolant connection (not shown). The external sealing layers 11 are in turn made of crimped sheet metal, sealing taking place on crimps 14 relative to the connecting flanges 3 and 5 with sealing contact over a small area so that there is only a heat transfer region of small area between the flanges 3, 5 and the sealing layers 11. The thermal load acting on the sealing element 9 from the exhaust gas flow itself is reduced by heat dissipation by way of the cooling medium located in the space 15.

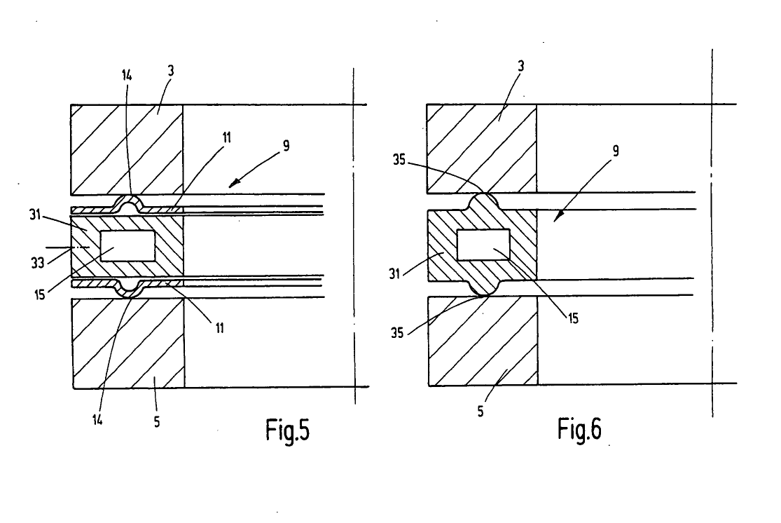

FIG. 6 shows an embodiment which corresponds to the example from FIG. 5, aside from the fact that the sealing element 9 is made in a single layer, the annular body 31 forming both the space 15 for the cooling medium and also the projecting sealing regions 35 for small-area contact with the connecting flanges 3 and 5.

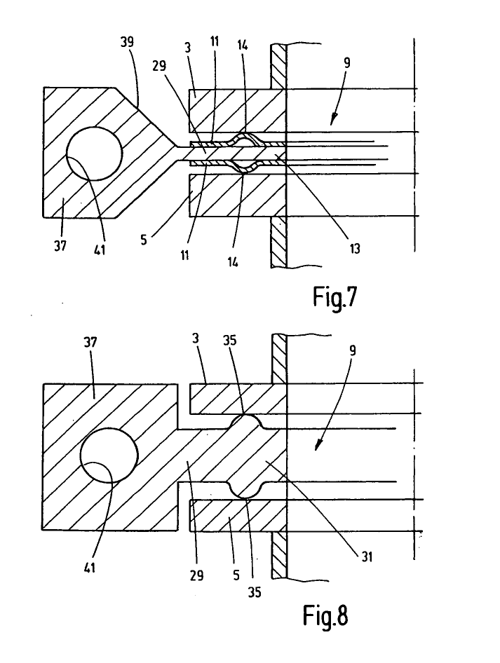

FIG. 7 illustrates an embodiment in which the sealing element 9 is in turn composed of several layers, external sealing layers 11 of crimped sheet metal in the region of the crimps 14 adjoining the connecting flanges 3 and 5, forming a seal, contact in turn taking place over a small area. Between the sealing layers 11 there is in turn an intermediate layer 13 of good thermal conductivity. But, unlike in the examples from FIGS. 2 and 4, the end region 29 of the intermediate layer 13 which projects to the outside is adjoined by a cooling body 37 in one piece, which forms cooling surfaces 39 and, in addition, is also provided with an inner cooling channel 41 which contains a cooling medium, and there can be an active or passive cooling system.

FIG. 8 finally shows an embodiment which corresponds to the example from FIG. 7, aside from the fact that the sealing element 9 is made in a single layer, the annular body 31, as in the example from FIG. 6, sealing with projecting sealing regions 35 in small-area contact with the connecting flanges 3 and 5. The annular body 31 on its end region 29 undergoes transition directly into the cooling body 37 which, as in FIG. 7, has an inner cooling channel 41.

It has been found that by using the invention in exhaust gas systems of the aforementioned type, in operation the temperature of the sealing element can be reduced by approximately 100 to 150° C., as a result of which the fatigue strength of the sealing arrangement is increased. Still greater temperature reductions can be achieved in the use of cooling systems with high cooling performance.

1. A sealing arrangement for connections on lines conducting hot gases, particularly exhaust gas lines on internal combustion engines, with at least one sealing element (9) which encloses the pertinent gas channel gastight relative to its outer side, characterized in that the sealing arrangement (1) has a means (13, 15, 21, 27, 37, 41) which reduces the thermal load on the sealing element (9).

2. The sealing arrangement according to claim 1, characterized in that the means is interactively connected to the sealing element (9) and/or to a connecting flange (3, 5) which forms part of the sealing arrangement (1).

3. The sealing arrangement according to claim 2, characterized in that there is a heat dissipating means (13, 15, 21, 27, 41),

4. The sealing arrangement according to claim 2, characterized in that there is a heat-insulating means (27).

5. The sealing arrangement according to claim 2, characterized in that there is a means (13, 27, 29) which causes combined cooling and heat insulation.

6. The sealing arrangement according to claim 3, characterized in that the heat-dissipating means comprises a space (15) for a liquid or gaseous cooling medium.

7. The sealing arrangement according to claim 6, characterized in that the space (15) for the cooling medium has at least one coolant channel (21, 41).

8. The sealing arrangement according to claim 6, characterized in that the space (15) is configured at least partially within the sealing element (9).

9. The sealing arrangement according to claim 8, characterized in that the space (15) is connected to cooling channels (21, 41) which are located outside the sealing element (9).

10. The sealing arrangement according to claim 9, characterized in that the outside cooling channels (21) are provided with external cooling ribs (23) for heat dissipation.

11. The sealing arrangement according to claim 3, characterized in that the sealing element (9) is designed with several layers with one external sealing layer (11) at a time which seals on the contact surface or flange surface (3, 5) and that the space (15) for the cooling medium and/or an intermediate layer (13) with good heat conduction is located between the external sealing layers (11) of the sealing element (9).

12. The sealing arrangement according to claim 5, characterized in that there is insulating material (27) as a heat-insulating means between the flange surfaces (3, 5) and facing surfaces of the sealing element (9).

13. The sealing arrangement according to claim 11, characterized in that the intermediate layer (13) with good heat conduction with an end region (29) which forms heat dissipation surfaces projects to the outside over the external ends of the sealing layers (11).
